(19) United States
(12) Patent Application Publication
(10) Pub. No.: US 2007/0028782 A1
(43) Pub. Date: Feb. 8, 2007

(54) Meat-smoking device

(76) Inventor: Fu Chiu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/195,621

(22) Filed: Aug. 3, 2005

(51) Int. Cl. A23B 4/044

(52) U.S. Cl. 99/482

(57) ABSTRACT

The present invention includes a smoking cabinet and a central air supply system. The central air supply system includes an air-draining pipe and an air supply pipe connected with the smoking cabinet. The other end of the air supply pipe is connected with an air supply unit to supply cooking smoke to the smoking cabinet. The air supply pipe is connected with a compression motor. The other end of the air-draining pipe is connected with an air-draining pump to drain cooking smoke from within the smoking cabinet, and the air-draining pump is connected with an air-recycling unit. Thus, the compression motor and the air-draining pump respectively supply and drain compressed cooking smoke repeatedly so the meat inside the smoking cabinet swells and shrinks repeatedly. The cooking smoke can penetrate the meat quickly so that it the time required to cook the meat is drastically reduced and keeps the meat fresh.

### BACKGROUND OF THE INVENTION

1. Field of the Invention

The present invention relates to a meat-smoking device, and in particular to a smoked meat cabinet with a central air supply system so as to keep the smoked meat fresh and to reduce the time needed to cook the meat.

2. Description of Related Art

Conventional meat-smoking devices primarily produce and supply cooking smoke to keep meat fresh. The meat-smoking device includes a coconut shell-burning furnace, a cooling cylinder, a cooling water machine, an air compressor, a compression tank and an air supply portion. An electrical plate is positioned within the furnace, and a plurality of filters are positioned within the cooling cylinder in communication with the furnace by a first conduit. The cooling water machine is respectively connected with ends of a first water supply pipe and a second water supply pipe. The first water supply pipe is in series connected with a cartridge-like standard filter jar and odor filter jar. A plurality of nozzles are positioned at the other end of the first water supply pipe inserted into the upper portion of the cooling cylinder. The plurality of nozzles sprinkle cooling water at the filters. The second water supply pipe communicates with the lower portion of the cooling cylinder. Moreover, the air compressor is connected with the cooling cylinder by a second conduit that is in series connected with a cartridge-like standard filter jar and odor filter jar. The air compressor is connected with a third conduit and used to supply cooking smoke. The compression tank connects with a free end of the third conduit and is used to store the cooking smoke.

As shown in FIG. 1, the air supply portion of the conventional meat-smoking device includes a smoking cabinet 90, a supporting frame 91, a trolley 92 and a central air supply system. The smoking cabinet 90 supplies the cooking smoke produced from the air supply portion, and the supporting frame 91 has separate supporting plates 911. Several pieces of meat 93 are placed on the supporting plate 911, and the smoking cabinet 90 is adapted to receive the supporting frame 91. The trolley 92 is used to support the supporting frame 91 and moves between the smoking cabinet 90 and predetermined locations. The central air supply pipe system includes air-draining pipes and air supply pipes respectively connected with the smoking cabinet 90. The air-draining pipes are used to drain air within the smoking cabinet 90 via an air-draining pump 94, and the air supply pipes are used to supply the cooking smoke into the smoking cabinet 90 via the compression tank 95. The conventional meat-smoking device uses the cooking smoke to cook meat so that the meat is preserved, sterilized and kept fresh.

However, the conventional meat-smoking device supplies the cooking smoke into the smoking cabinet to cook the meat and it takes 48 hours to cook. Obviously, this is a time-consuming process. When the conventional meat-smoking device is used to cook fish, much more time is needed for cooking, as fish goes off even faster than most kinds of meat.

### SUMMARY OF THE INVENTION

It is an object of the present invention to provide a meat-smoking device. The present invention saves cooks meat much faster than conventional devices and keep the meat fresh.

To achieve the above object, a meat-smoking device includes a smoking cabinet and a central air supply system. The central air supply system includes an air-draining pipe and an air supply pipe respectively connected with the smoking cabinet. The other end of the air supply pipe is connected with an air supply unit that is used to supply the cooking smoke. Moreover, the air supply pipe is connected with a compressed motor that compresses the cooking smoke. The other end of the air-draining pipe is connected with an air-draining pump that drains the cooking smoke from within the smoking cabinet, and the air-draining pump is connected with an air-recycling unit.

According to another embodiment of the present invention, a meat-smoking device includes a smoking cabinet and a central air supply system. The central air supply system includes an air-draining and supply pipe connected with the smoking cabinet. The other end of the air-draining and supply pipe is connected with an air-recycling unit that is used to supply and collect the cooking smoke. The air-draining and supply pipe is connected with a compression motor and an air-draining pump. The compression motor is used to compress the cooking smoke, and the air-draining pump drains cooking smoke from within the smoking cabinet.

According to the present invention, the central air supply system includes the compression motor and the air-draining pump to supply and drain compressed cooking smoke repeatedly so that the meat within the smoking cabinet swells and shrinks repeatedly. Thus, the cooking smoke can penetrate into the meat quickly thus saving lots of time. Particularly, the present invention can be applied to cook fish so the present invention keeps the meat fresh.

### BRIEF DESCRIPTION OF THE DRAWINGS

The present invention can be fully understood from the following detailed description and preferred embodiments with reference to the accompanying drawings, in which:

FIG. 1 is a perspective view of a conventional meat-smoking device;

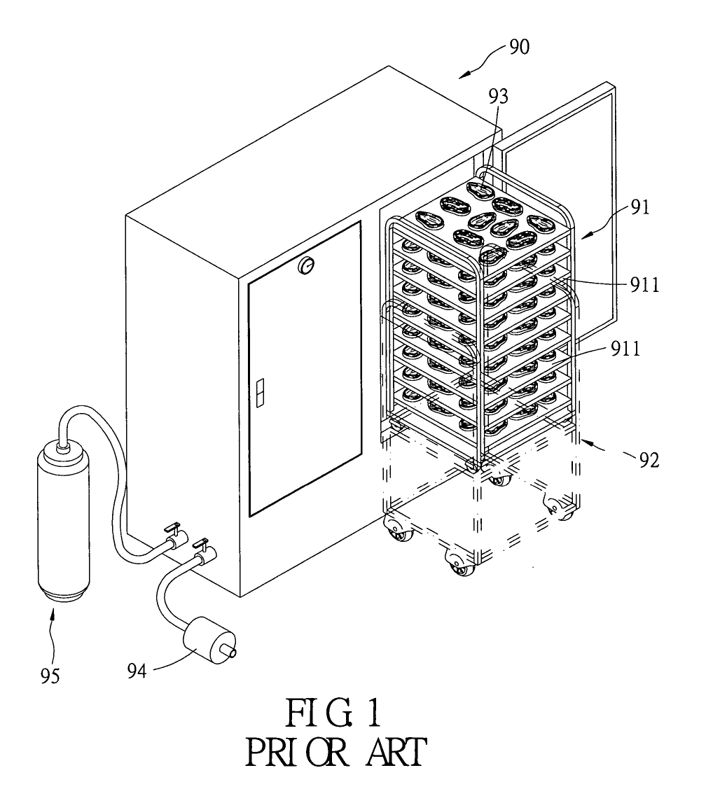

FIG. 2 is a perspective view of a meat-smoking device according to the first embodiment of the present invention;

FIG. 3 is another perspective view of a meat-smoking device according to the first embodiment of the present invention; and

FIG. 4 is a perspective view of a meat-smoking device according to the second embodiment of the present invention.

### DETAILED DESCRIPTION OF THE PREFERRED EMBODIMENTS

The following detailed description is of the best presently contemplated modes of applying the invention. This description is not to be taken in a limiting sense, but is made merely for the purpose of illustrating general principles of embodiments of the invention. The scope of the invention is best defined by the appended claims.

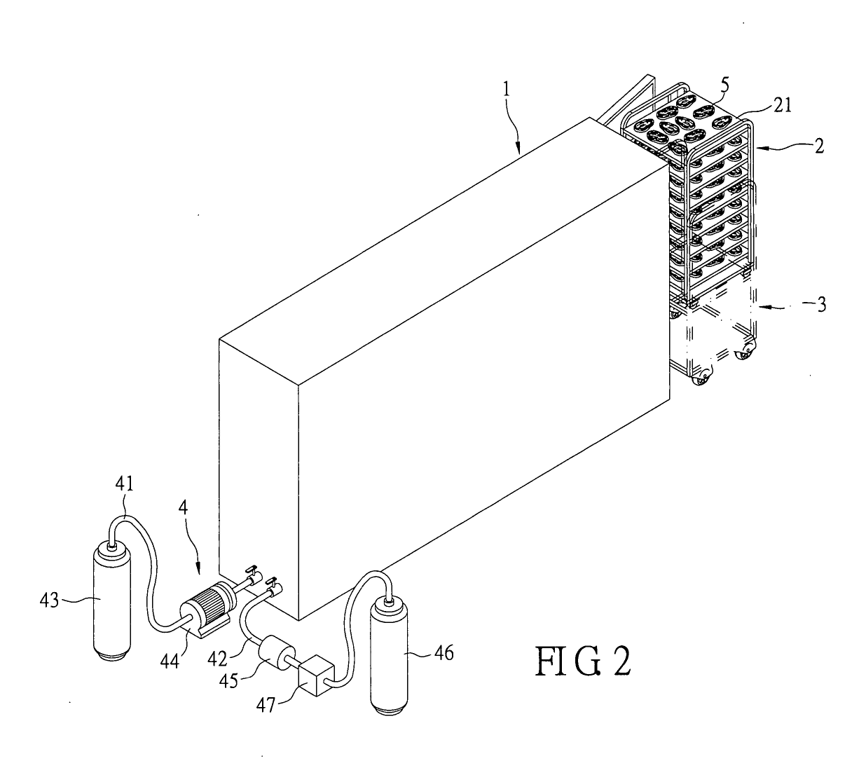

Reference is made to FIG. 2. FIG. 2 illustrates a perspective view of a meat-smoking device according to the first embodiment of the present invention. The present invention relates to the central air supply system of the meat-smoking device, and the central air supply system connects an air production system that is conventional and beyond the scope of the present invention. The description of the air production system has therefore been omitted.

According to the present invention, the meat-smoking device includes a smoking cabinet 1, a supporting frame 2, a trolley 3 and a central air supply system 4. The smoking cabinet 1 is hollow and receives the cooking smoke generated by the air production system. The volume of the smoking cabinet 1 can be changed to meet requirements. The smoking cabinet 1 can have either one-cabinet, two-cabinets, three-cabinets or four-cabinets to receive various types of supporting frames 2. According to the embodiment, the smoking cabinet 1 has four-cabinet to receive four supporting frames 2. The smoking cabinet 1 also includes a cooling system (not shown) to maintain the internal temperature of the smoking cabinet 1 at 1° C. to 6° C.

The supporting frame 2 has separate supporting plates 21. Several pieces of meat can be placed on the supporting plate 21, and the smoking cabinet 1 is adapted to receive the supporting frame 2. The trolley 3 is used to support the supporting frame 2 and moves between the smoking cabinet 1 and predetermined locations.

The central air supply system 4 includes an air supply pipe 41 and an air-draining pipe 42 respectively connected with one side of the smoking cabinet 1. The other end of the air supply pipe 41 is connected with an air supply unit 43 (compression tank). The air supply unit 43 is connected with the air production system (not shown) of the meat-smoking device and stores the cooking smoke. Moreover, the air supply unit 43 is used to supply the cooking smoke into the smoking cabinet 1 via the air supply pipe 41 so as to cook the meat.

The air supply pipe 41 is connected with a compression motor 44 positioned between the air supply unit 43 and the smoking cabinet 1 so that the cooking smoke produced by the air supply unit 43 is properly compressed. Thus, the cooking smoke is compressed at a pressure of between 2 to 20 Kg/cm² and supplied to the smoking cabinet 1.

The other end of the air-draining pipe 42 is connected with an air-draining pump 45 that drains cooking smoke within the smoking cabinet 1 so that there a vacuum of −76 cm-Hg is created within the smoking cabinet 1. Moreover, the air-draining pump 45 is connected with an air-recycling unit 46 (compression tank) and used to drain and recycle the cooking smoke within the smoking cabinet 1. The air-draining pipe 42 is connected between the air-recycling unit 46 and the air-draining pump 45 and includes a filter unit 47 to filter out the recycled cooking smoke. Thus, dust in the smoking cabinet 1 is prevented from passing into the air-recycling unit 46.

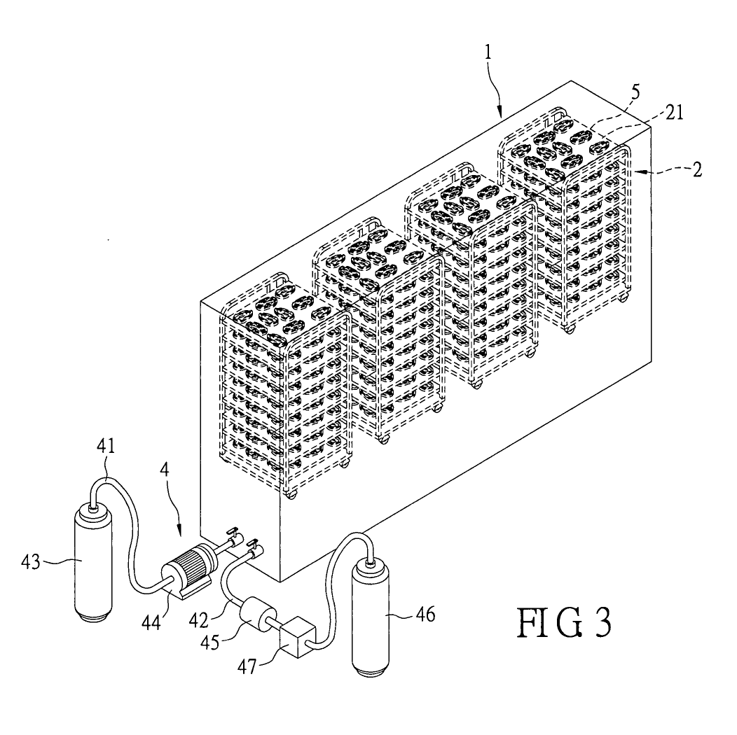

Reference is made to FIG. 3. According to the present invention, meat 5 is placed on supporting plates 21 of the supporting frame 2 and positioned within the smoking cabinet 1 using the trolley 3. Then, the air supply unit 43 is used to supply cooking smoke into the smoking cabinet 1 via the air supply pipe 41. The cooking smoke is compressed to between 2 and 20 Kg/cm² by the compression motor 44. The process of supplying compressed cooking smoke stops after a predetermined time. Next, the air-draining pump 45 is activated to drain the cooking smoke from within the smoking cabinet 1 so that the cooking smoke is collected by the air-draining pump 45 and sent back to the air-recycling unit 46. To achieve this, a vacuum of −76 cm-Hg is crated within the smoking cabinet 1. The process of draining compressed cooking smoke stops after a predetermined time. The process of supplying and draining the cooking smoke from within the smoking cabinet 1 takes 2 to 3 hours. The process of cooking the meat is completed so that the meat is preserved, sterilized and kept fresh.

According to the present invention, the central air supply system 4 of the meat-smoking device includes the compression motor 44 and the air-draining pump 45 to supply and drain the compressed cooking smoke from within the smoking cabinet 1 repeatedly. Thus, the meat within the smoking cabinet swells and shrinks repeatedly so that the cooking smoke can penetrate the meat quickly. 2 to 3 hours is required to complete the process of cooking the meat. So, compared to conventional meat-smoking devices, the present invention so saves lots of time. Furthermore, when the present invention is applied to cooking fish, the present invention keeps the fish fresh.

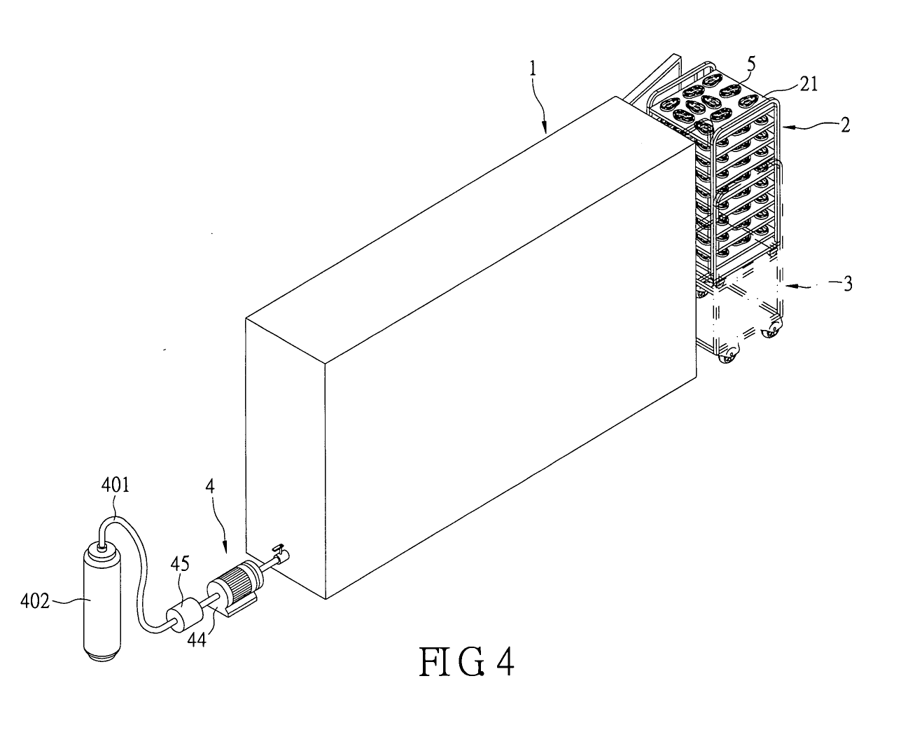

Reference is made to FIG. 4. According to the second embodiment of the present invention, the air supply pipe 41 and the air-draining pipe 42 of the first embodiment are integrated into an air-draining and supply pipe 401. The air supply unit 43 and the air-recycling unit 46 of the first embodiment are integrated into an air-recycling unit 402 (compression tank). The compression motor 44 and the air-draining pump 45 are positioned at the air-draining and supply pipe 401. According to the second embodiment, some components are integrated so that structure of the meat-smoking device is simplified and the cost is significantly reduced.

The air-recycling unit 402 supplies cooking smoke to the smoking cabinet 1 through the air-draining and supply pipe 401. The compression motor 44 compresses the cooking smoke, and the air-draining pump 45 drains cooking smoke from within the smoking cabinet 1. Thus, the cooking smoke is collected by the air-draining and supply pipe 401 and sent to the air-recycling unit 402. A vacuum is formed within the smoking cabinet 1. The compression motor 44 and the air-draining pump 45 operate alternatively to respectively supply and drain the cooking smoke.

The invention may be embodied in other specific forms without departing from the sprit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A meat-smoking device, comprising:
a smoking cabinet;
an air supply unit having cooking smoke stored therein;
a compressor having an inlet coupled to said air supply unit and an outlet coupled to said smoking cabinet, said compressor being selectively operable for pressurizing said smoking cabinet with said cooking smoke trapped therein;
an air recycling unit coupled to said smoking cabinet for storing cooking smoke removed from said smoking cabinet; and
an air draining pump coupled in fluid communication between said smoking cabinet and said air recycling unit, said draining pump being alternatively operable relative to said compressor for transferring said cooking smoke from said smoking cabinet to said air, recycling unit.

2. The meat-smoking device as claimed in claim 1, wherein said compressor pressurizes said cooking smoke within said smoking cabinet to a pressure within a range of 2 to 20 Kg/cm².

3. The meat-smoking device as claimed in claim 1, wherein said air draining pump evacuates said smoking cabinet to −76 cm-Hg.

4. The meat-smoking device as claimed in claim 1, further comprising a filter unit coupled in fluid communication between said air draining pump and said air recycling unit.

5-8. (canceled)

9. The meat-smoking device, comprising:
a smoking cabinet;
a compression tank having cooking smoke stored therein coupled in fluid communication with said smoking cabinet;
a compressor coupled between said compression tank and said smoking cabinet, said compressor being selectively operable for pressurizing said smoking cabinet with said cooking smoke trapped therein; and,
an air draining pump coupled between said smoking cabinet and said compression tank, said draining pump being alternatively operable relative to said compressor for returning said cooking smoke from said smoking cabinet to said compression tank for subsequent reuse, said air draining pump evacuating said smoking cabinet through said compressor.

10. The meat-smoking device as claimed in claim 9, wherein said compressor pressurizes said cooking smoke within said smoking cabinet to a pressure within a range of 2 to 20 Kg/cm².
